(19) United States
(12) Patent Application Publication
(10) Pub. No.: US 2004/0049886 A1
(43) Pub. Date: Mar. 18, 2004

(54) Elastic hinge for a notebook computer

(75) Inventor: Sheng-Nan Lu, Taipei Hsien (TW)

Correspondence Address: Cooper & Dunham LLP, 1185 Avenue of the Americas, New York, NY, 10036, US

(73) Assignee: Shin Zu Shing Co., Ltd.

(21) Appl. No.: 10/245,357

(22) Filed: Sep. 17, 2002

(51) Int. Cl. E05D 11/08

(52) U.S. Cl. 16/342

(57) ABSTRACT

A hinge for a notebook computer is composed of a pintle and two barrels. The first barrel is provided outside the first part of the pintle, and the second barrel is provided outside the second part of the pintle. At least one pin diametrically extends through the pintle. The first barrel has a lug formed at an end facing the pin and abutting the pin. When the computer is closed, the first barrel is compressed to provide an elastic force to open the monitor.

### BACKGROUND OF THE INVENTION

1. Field of the Invention

The present invention is related to an elastic hinge for a notebook computer, and more particularly to a hinge which has an elastic force to automatically raise a monitor of the notebook computer.

2. Description of Related Art

A notebook computer comprises a body and a monitor pivotally mounted on the body by hinges. When the computer is closed, the monitor abuts the body and is fastened by a locking member.

However, the conventional hinge does not provide an elastic force to slightly raise the monitor when a user wants to open the computer, and the user may fumble in trying to separate the two hinged portions.

Therefore, the invention provides a hinge for a notebook computer to mitigate and/or obviate the aforementioned problems.

### SUMMARY OF THE INVENTION

The main objective of the invention is to provide a hinge for a notebook computer which can provide an elastic force to slightly raise a monitor when a locking member of the computer is released.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a notebook assembled with hinges in accordance with the invention;

FIG. 2 is an exploded perspective view of the hinge in FIG. 1;

FIG. 3 is a perspective view of the hinge in FIG. 1;

FIG. 4 is a side view showing the hinge from an open status to a closed status;

FIG. 5 is a side view of the hinge in the closed status; and

FIG. 6 is a side view showing the monitor automatically raised.

### DETAILED DESCRIPTION OF THE PREFERRED EMBODIMENT

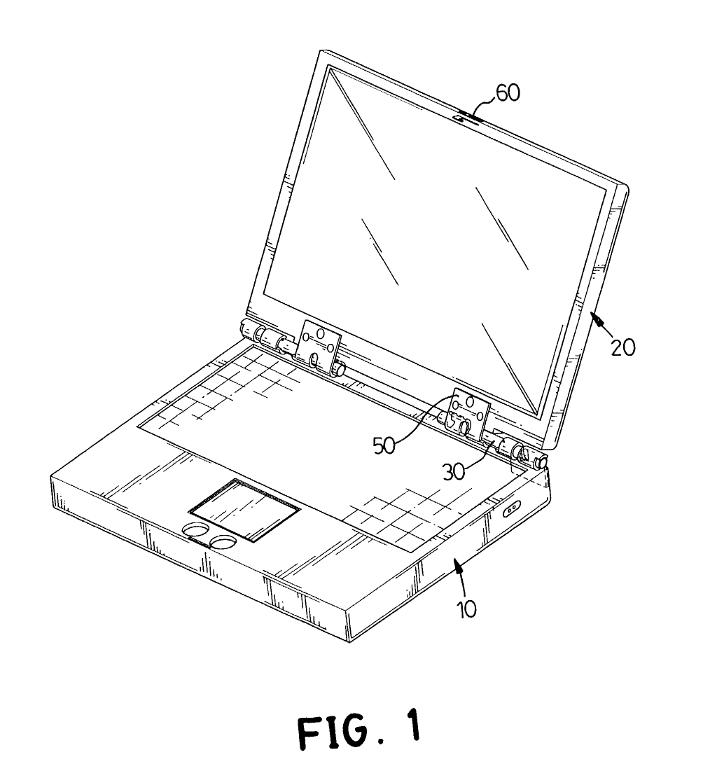

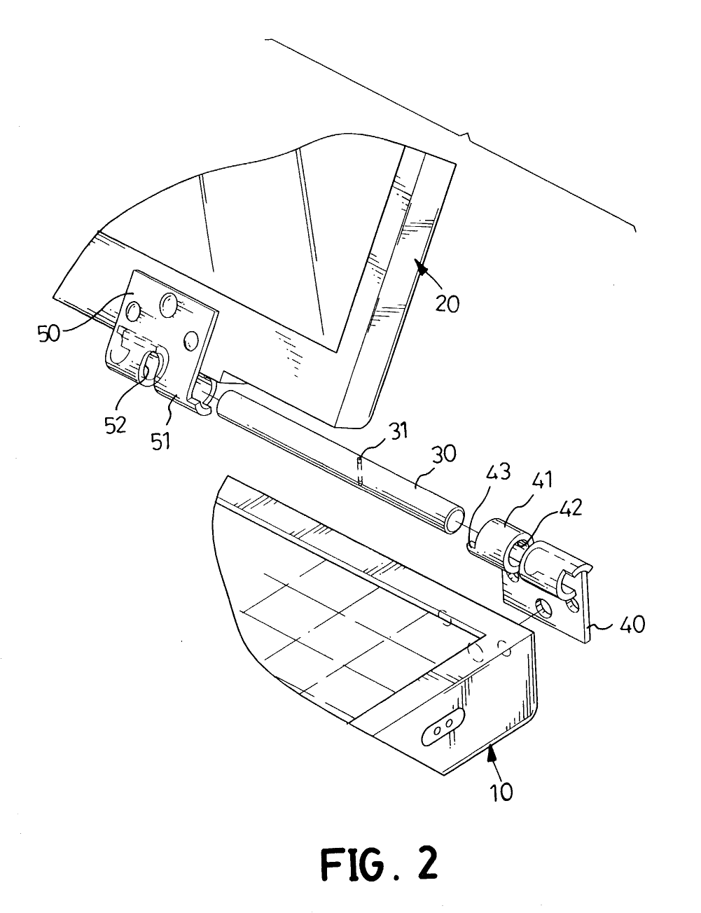

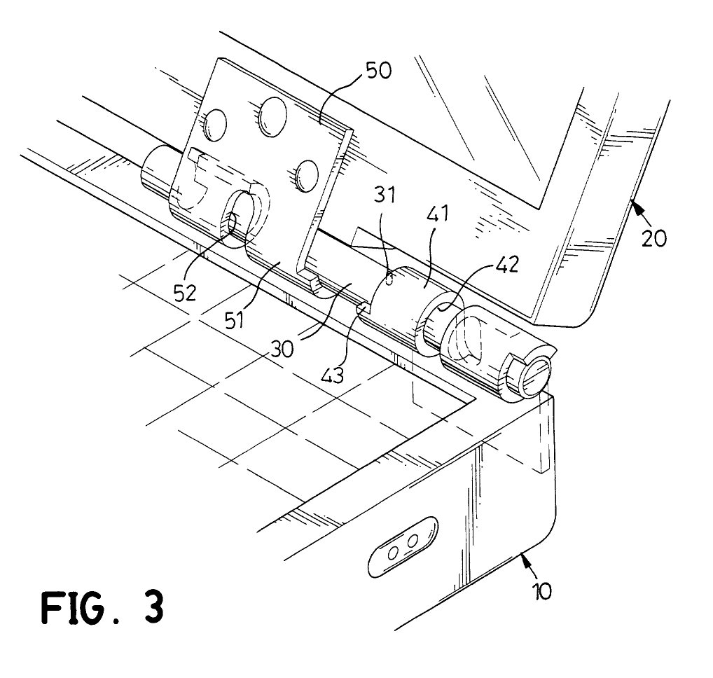

Referring to FIGS. 1-3, a notebook computer is composed of a body (10) and a monitor (20) pivotally mounted on the body (10) by two hinges. The monitor (20) has a locking member (60) to fasten the monitor (20) on the body (10) when the computer is closed.

The elastic hinge in accordance with the invention is composed of a pintle (30), a first barrel (40), and a second barrel (50). The first barrel (40) is mounted on the body (10), and the second barrel (50) is mounted on the monitor (20).

The pintle (30) has a first part, a second part and a middle part between the first part and the second part. A pin (31) diametrically extends through the middle part of the pintle (30), and has two ends (not numbered) protruded from an outer periphery of the pintle (30).

The first barrel (40) is rotatably provided outside the first part of the pintle (10), and has two first C-like tubular portions (41) aligned with each other, and each portion (41) has a first passage (42). The first C-like tubular portion (41) adjacent the pin (31) has a lug (43) formed at an end facing the pin (31) and abutting the pin (31). The first barrel (40) further has a first plate extending therefrom and fastened on the body (10).

The second barrel (50) is securely provided outside the second part of the pintle (10), and has two second C-like tubular portions (51) aligned with each other, and each portion (51) has a second passage (52). The second barrel (50) further has a second plate extending therefrom and fastened on the monitor (20).

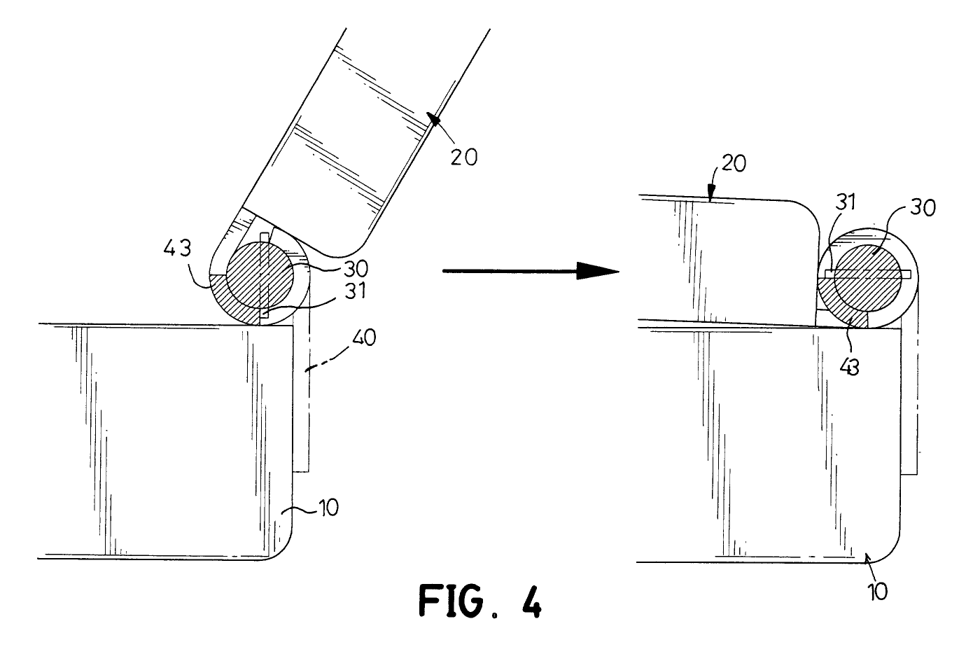

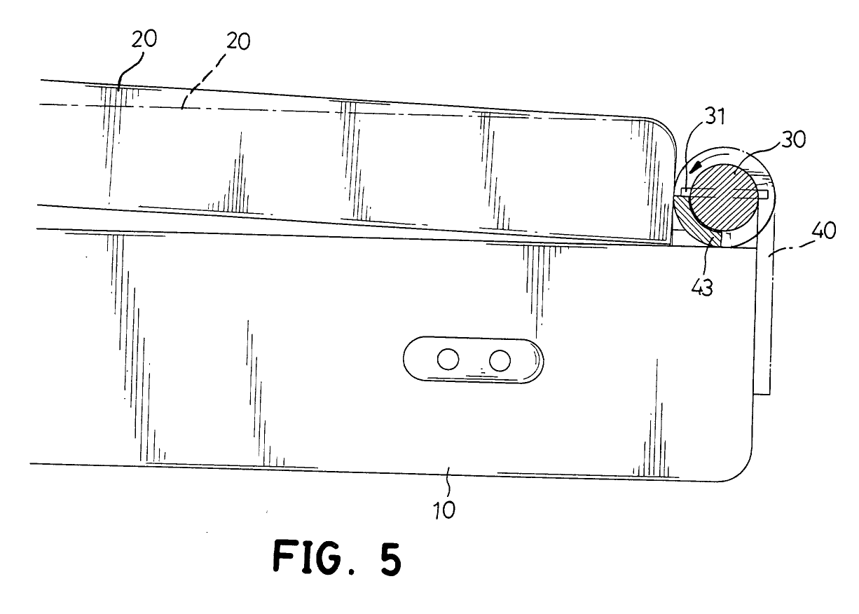

Referring to FIGS. 4-5, when the monitor (20) is raised, a first side of the lug (43) abuts the first end of the pin (31), and the monitor (20) is positioned. When the monitor (20) is pivoted down to abut the body (10), a second side of the lug (43) abuts the second end of the pin (31). In this case, the monitor (20) does not completely abut the body (10), and there is a gap between the monitor (20) and the body (10). A user must press the monitor (20) down to attach the locking member (60) to the body (10) to close the computer, so that the pin (31) presses against the lug (43) to compress the first barrel (40).

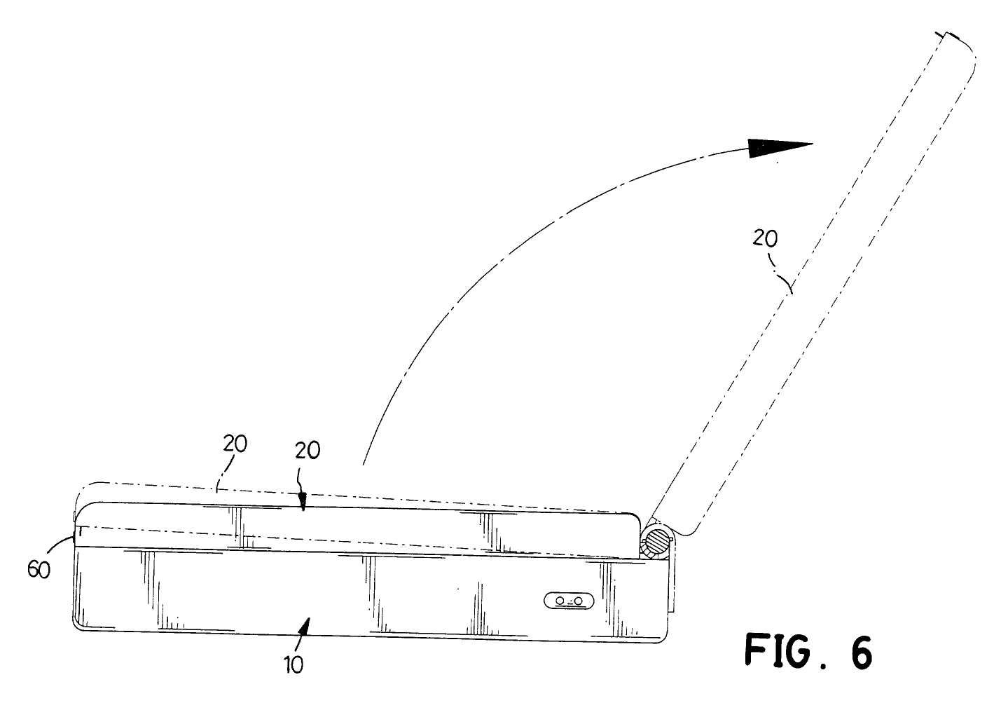

Referring to FIG. 6, when the user releases the locking member (60) to open the computer, the elastic force of the compressed first barrel (40) can slightly push the monitor (20) to pivot upwards, so that the user can easily and conveniently raise the monitor (20).

According to another embodiment of the present invention, the first barrel (40) is securely provided outside the pintle (10), and the second barrel (50) is rotatably provided outside the pintle (10). The second barrel (50) has the lug abutting the pin (31).

According to a further embodiment of the present invention, two pins are separately formed at the middle part of the pintle (30). The first barrel (40) and the second barrel (50) each have a lug abutting the corresponding pin (31).

The two configurations mentioned above have the same function and effect, and will not depart from the scope of the invention.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An elastic hinge for a notebook computer, the hinge comprising:
a pintle (30) with a first part, a second part, and a middle part between the first part and the second part, the pintle (10) having at least one pin (31) diametrically extending through the middle part, and the at least one pin (31) having two ends protruded from an outer periphery of the pintle (30);
a first barrel (40) provided outside the first part of the pintle (30), the first barrel (40) having two first C-like tubular portions (41) aligned with each other, and a first lug (43) formed at an end of the first C-like tubular portions (41) facing the at least one pin (31) and abutting the at least one pin (31); and
a second barrel (50) provided outside the second part of the pintle (10), the second barrel (50) having two second C-like tubular portions (51) aligned with each other.

2. The hinge as claimed in claim 1, wherein the pintle (10) has two pins (31) separately formed at the middle part; the first lug (43) of the first barrel (40) is abutted the pin (31) adjacent the first barrel (40); and the second barrel (50) has a second lug formed on an end of the second C-like tubular portions (51) facing the pin (31) and abutting the pin (31) adjacent the second barrel (50).
